(19) United States
(12) Patent Application Publication
(10) Pub. No.: US 2007/0299828 A1
(43) Pub. Date: Dec. 27, 2007

(54) Method and Apparatus for Processing Heterogeneous Data

(75) Inventors: Julie LEWIS, San Mateo, CA (US); Patricia GARDNER, Homewood, CA (US); Dominik KACPRZAK, Kingwood, TX (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: DIGITAL MOUNTAIN, INC., Foster City, CA (US)

(21) Appl. No.: 11/757,989

(22) Filed: Jun. 4, 2007

Related U.S. Application Data
(60) Provisional application No. 60/811,292, filed on Jun. 5, 2006.

(51) Int. Cl. G06F 17/30; G06F 17/00

(52) U.S. Cl. 707/3; 707/1; 715/500

(57) ABSTRACT

Methods and apparatuses to compile heterogeneous data, regardless of origin, into a single, unified system, which provides customers with the ability to control the process for managing their data for viewing, categorizing/cataloging/classifying, annotating, converting, storing and exporting their data according to their own specifications. One embodiment includes: providing a user interface to a customer; receiving a plurality of heterogeneous digital files from the customer; receiving, via the user interface, a query specification from the customer to select a subset of the digital files according to the query specification; receiving, via the user interface, input to manage a workflow for review of the subset of digital files; receiving, via the user interface, input data related to the review of the subset of digital files; and generating a version of the subset of digital files based on the received input data related to the review of the subset of digital files.

### CROSS-REFERENCE TO RELATED APPLICATIONS

The present application claims the benefit of the filing date of Provisional U.S. Patent Application Ser. No. 60/811,292, filed Jun. 5, 2006 and entitled “Method and Apparatus for Displaying and Editing Heterogeneous Data,” the disclosure of which is hereby incorporated herein by reference.

### BACKGROUND

Different computer operating systems and/or application programs have been used to generate and store data in various file types and formats. Software revisions, obsolescence, format changes, localization, and translations further increase the variety of existing formats.

There are situations where disparate data in different languages and character sets are brought together from different locations, operating systems, software applications, and individuals for the purpose of collecting, organizing, cataloging, examining or viewing. It could be very expensive, if not impossible, for a single entity to own, run and support all of the software and/or hardware systems which can process all the data the users of the entity might use. The ability to generate data in various formats has outstripped the ability to collect, organize and view the data in general.

To facilitate searching and viewing across disparate datasets, the files and data can be converted to a unified format (such as plain text), indexed, and converted to a format conducive to human viewing. In addition to searching and viewing, there may be a need to perform more complex operations with the data such as filtering, annotations, conversion, editing and export.

A current methodology for managing, viewing and annotating heterogeneous data uses multiple disjoint processes, such as: preparing the data; preparing the viewing application; loading the data; viewing and annotating the data; capturing and preserving the annotations; converting the data; and exporting the data and related files.

In one existing system, electronic files are converted into a graphical image format such as TIFF or PDF. The data and metadata are extracted and stored in a database to facilitate searches. A customer consults with a vendor of the system at various stages of the process of obtaining a sample viewing of the data that is managed by the system of the vendor. For example, the customer is required to meet with one or more representative of the vendor to discuss initial specifications for the project. After an estimating and contract process, the vendor prepares the data and viewing system according to the customer's specifications while the customer waits. The vendor utilizes multiple software applications and moves data around multiple hardware systems to prepare the data according to the customer's specifications. Once the vendor has information about the data preparation, the customer is notified to view the data in order to determine whether it meets their requirements. The process is iterated until the customer expectation is met.

Then, the customer and the vendor meet to specify the viewing requirements. The vendor creates a viewing system for the customer and makes the datasets available for viewing in documents that have a common file type. The customer then begins to view, categorize and annotate the documents.

After the first viewing of the documents, the customer may add additional incremental requirements. For example, the customer may require changes to the system(s), changes to annotations, changes to categorizations, changes of users involved, changes of parameters to query the dataset, additional datasets, etc. Many iterations of re-specification, recycling and reprocessing, involving vendor interaction, lead to delays.

After viewing the datasets, additional operations are required before the data processing is completed for export from the system. For example, the customer provides specification to the vendor for the capture and preservation of annotations and edits made during the viewing process along with how the data should be stored or converted. The vendor implements the requirement while the customer waits. The customer reviews the implementation. The iteration of re-specification and reprocessing continues until customer's requirements are met.

Then, the annotated, edited documents flow through an export process. For example, the customer provides parameters to the vendor to produce the annotated, edited documents. The customer awaits results. The exported results are checked by the customer for compliance to specifications with possible further iterations.

In another system, electronic files are collected and stored in their native format. From the files in their native format, the data is directly extracted and stored in a database to facilitate searches.

The traditional systems provide the customer with limited functionalities but no control over the processes required to manage their own projects on-line.

### SUMMARY OF THE DESCRIPTION

Methods and apparatuses to compile heterogeneous data, regardless of origin, into a single, unified system, which provides customers with the ability to control the process for managing their data for viewing, annotating, converting, storing and exporting their data according to their own specifications, are described herein some embodiments are summarized in this section.

In one embodiment, a method includes: providing a user interface to a customer; receiving a plurality of heterogeneous digital files from the customer; receiving, via the user interface, a query specification from the customer to select a subset of the digital files according to the query specification; receiving, via the user interface, input to manage a workflow for review of the subset of digital files; receiving, via the user interface, input data related to the review of the subset of digital files; and generating a version of the subset of digital files based on the received input data related to the review of the subset of digital files.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows a block diagram of a system of one embodiment.

FIG. 2 shows a diagram of the use of modules of a system according to one embodiment.

FIG. 3 shows a review module according to one embodiment.

FIG. 4 shows a block diagram example of a data processing system which may be used in various embodiments.

FIG. 5 shows a method for document management according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

One embodiment of disclosure includes a comprehensive and sophisticated system which puts functional control in the hands of the customer. In one embodiment, a system provides the customer with the ability to search, filter, and view heterogeneous data. The data may be generated via various operating systems, or various software applications, and/or in different languages. In one embodiment, the system allows the user to view and edit their data.

In one embodiment, the system can process various file types, such as multi-media files, files from non-Windows operating system, such as Linux, Unix, Mac OS, and files in non-English language documents, etc. In one embodiment, the system can accept files that the system may not have the software processing capability to directly process the files and can make an arrangement to process the files so that the files can be included in the dataset.

In one embodiment, a computer based system provides the user a single interface for processing, viewing, annotating, categorizing/cataloging/classifying, converting, and/or exporting data and files which have a heterogeneous composition (operating system, file type, format, etc.). In one embodiment, the system can be accessed on-line including the upload of initial data and the download of exported results. In one embodiment, a browser or a graphical interface is used to implement the single interface.

The systems and methods of the disclosure solve many of the problems outlined in the background section above over a wide range of fields. These methods can be adapted for a particular need such as legal electronic data discovery, medical record management, processing of archival information such as historic web sites or datasets, or record review and management. The system may also be used to support due diligences for mergers and acquisitions and regulatory compliance, in addition to organizing home office and consumer computer files.

In one embodiment, a user interface is provided to allow the user to manage their project, requirements, specifications, etc. Thus, the user is not required to rely on a vendor for managing their project. The user can utilize the self-service nature of the system and bypass the repetitive vendor negotiations, specifications and iterations, after the vendor initializes and authorizes the user. Users are not required to purchase and install multiple applications to achieve their goals.

In one embodiment, after the system is set up, the user can manage their project by themselves. For example, the user can perform data upload, change parameters for annotation (e.g., edits, categories, users, etc.), query, filter, view, annotate, convert, and export their data. In one embodiment, the control can also be partially delegated to other users and tracked under a hierarchy.

The initial data formats can be electronic or non-electronic (e.g., paper), originated in various operating systems and/or software applications (regardless of version), stored in multiple locations (both physically and virtually), and be written in English or non-English languages or character sets.

The data can be captured in a wide-range of file types including non-text based files such as audio and visual files (multimedia files). A workflow is built in the system to identify and resolve various file types to avoid rejecting documents and returning the rejected documents to the user.

In one embodiment, the system can process data collected from multiple sources and locations of multiple data types and present them for viewing in a common user environment; the workflows and diverse file types can be comprehended at once by single or multiple users within a unified framework.

In one embodiment, various data related to the activities of the files within the system (e.g., creation, use, storage, etc.) are recorded to ensure a clear audit trail. Data are processed without contamination or loss of integrity to the original files. In one embodiment, a centralized server system is used to implement the functions for managing the heterogeneous dataset to reduce or minimize the chance of data corruption or loss in comparison with traditional methods.

In one embodiment, a single computer or multiple computers are used to implement the data processing system. Virtualization and multi-threading are used to decouple hardware and software processes. The system and customers can be distributed geographically and shared between multiple customers or groups of customers but in a coordinated fashion.

In one embodiment, a server system includes one or more of: an administrative module, a workflow allocation module, a viewing module, and a production module. Individual modules within the system are useful in combinations or as isolated applications.

In one embodiment, an administrative module and/or a workflow allocation module can be used to administrate the overall user experience and parameters, with the ability to manage users of the application, parsing of files and data to users for viewing, and other unique and powerful functions, such as creating new project sites, importing data into the system, defining criteria for identification and handling of redundant files or data, controlling how the system handles parent/attachment situations, constructing and applying filters to the data, defining subjective review fields, managing review data, and/or defining workflow for tasks performed during the viewing process, etc. In one embodiment, administrators can perform global changes and control which modules are available to viewers, such as searching, global annotations, and filtering.

In one embodiment, a viewing module is used to control the presentation of the data to the customer/user. The viewing module allows the customer to view a graphical representation of the electronic file or dataset, such as in HTML presented by a browser, to view certain file types in their native applications, to annotate files and datasets, and to see parent/attachment relationships at a glance.

In one embodiment, the viewing module has the ability to search and filter files and data, apply global comments to a set of files and data or to a specific sub-set, redact information from a file or dataset at both visual and actual text levels, view instances of redundant files within the full data collection, and request resolution of conflicts from a third party. These features provide new functionality and efficiencies for both the customer end user and those administering the application.

In one embodiment, the production module provides the user with the ability to set up the parameters for identifying and isolating data that they would like to process and export. One embodiment of the production module provides the tools to convert data, capture classification or annotation information, define the parameters and format for the export of converted data and files, and perform the export.

In one embodiment, the system supports multiple levels of user accounts, such as administrator, first level reviewer, second level reviewer, etc. In one embodiment, a user hierarchy can collapse to a single level in the degenerate case of a single user.

For example, administrators have functional control over the system; and they are responsible for the management of the site/projects, its users, and the data. In one embodiment, the administrators are the highest level in this example hierarchy.

The first level reviewers are the lowest level in this example. These users are generally tasked with taking the first iteration at viewing the data, often on a file by file basis. The first level reviewers apply subjective classifications to the files based on their interpretation of the relevance of the file to the project parameters. The identification of redundant or duplicate files in the system provides a great time savings for the first level reviewers.

In one embodiment, the system provides the first level reviewers with an automated method for escalating classification disputes between the first level reviewers, and the functions to search, filter, apply global classifications and/or annotations to the files. The ability to control access to these functions is in the control of the administrator. Based on the configuration parameters specified by the administrator, some of these functions may not be available to some or all of the first level reviewers.

The second level reviewers are the mid-level in this example. In one embodiment, the second level reviewers are provided with greater functionality than a first level reviewer, but not as wide spread control as the administrator. Second level reviewers can perform additional functions such as monitoring the work of a first level reviewer or a group of first level reviewers, resolve classification conflicts, and override classifications made by the first level reviewers. In one embodiment, the functionality provided to the second level reviewers can be set by the administrator.

Alternative embodiments can include more or less levels and extensions, such as executive or regulatory reviewer, more severely constrained reviewers, work flow manager, etc. Some implementation of the system can have more or less of the functions described above.

In one embodiment, the system provides a user interface to allow customers to manage their own heterogeneous data pulled from its native environment in a self-service fashion, which provides them with control of various functions to display, categorize/catalog/classify, annotate, and manipulate the files from one uniform interface.

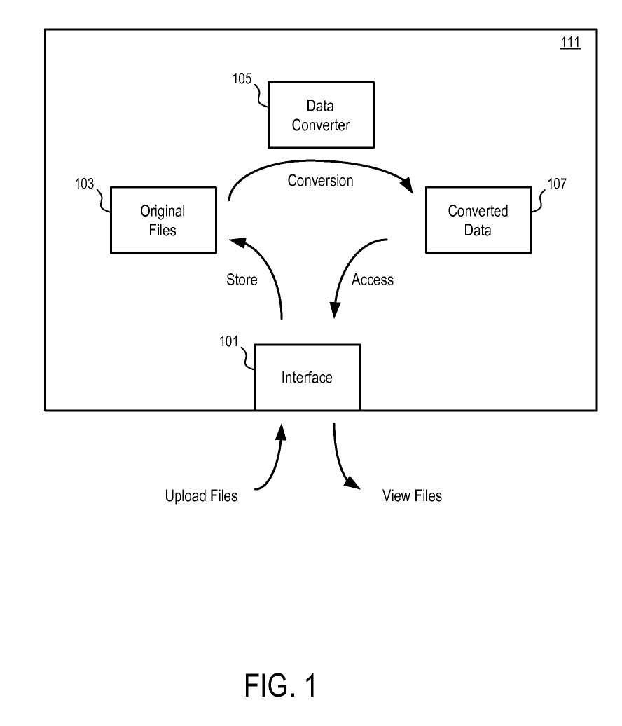

FIG. 1 shows a block diagram of a system of one embodiment. In FIG. 1, source files of heterogeneous data that has been collected or acquired from various sources (e.g., operating systems, software applications, etc.) are uploaded through the interface (101) and stored as the original files (103) in the system (111).

In one embodiment, the interface (101) includes a web interface, which allows one or more users to access the system (111) via a web browser. Alternatively, a standalone client application program can be used to provide the uniform user interface to access the system (111) over a network connection. Alternatively, a standalone application program running on the computer system of the customer may include the data conversion capability of the system (111). In one embodiment, the entire system (111) is implemented as a standalone application running on the computer system of a customer.

In one embodiment, one or more servers (e.g., web servers or other data servers, such as file servers or file transfer servers) can be used to implement the interface (101).

In FIG. 1, the data converter (105) is used to convert the heterogeneous data in the original files (103) into the converted data (107) in a common or generic format. During the conversion process data related to the creation, use, and storage of files and data is recorded/petrified; and the original files and data are retained. The converted data (107) can be selected, viewed via the interface (111).

In one embodiment, the interface (101) allows a customer user to load the original data into the system, instead of having to rely upon the representatives of a vendor of a system. After the metadata and text are extracted from the uploaded documents, the extracted metadata and text are indexed for searching functions. The interface (101) allows the customer user to construct filter and apply the filter, instead of having to rely upon the representatives of a vendor to construct query. The interface (101) allows the customer user to edit existing filters or constructs new filters, instead of having to rely upon the representatives of a vendor to modify the query.

In one embodiment, after the data are reviewed, selected, categorized/cataloged/classified, edited, and/or annotated, the system (111) can automate the production of the selected, categorized/cataloged/classified, edited, and/or annotated data for export from the system.

Thus, multiple costs and steps of a conventional system are eliminated in the disclosed system, which provides a streamlined, automated, one-stop approach in one embodiment.

In one embodiment, files of a single type from a single source can also be uploaded to the system, which then extracts the data (e.g., metadata and text) and presents the data for viewing, via a single user interface.

In one embodiment, after the original files (103) are transformed into the converted data (107), the system can further provide filtering and task assignment for data viewing, production and/or export functionalities.

In one embodiment, source files of multiple file types from various applications, such as productivity tools, video, audio, drafting, etc., can be uploaded into the system as the original files (103). The data can be uploaded from file storages of multiple types, such as network storage, desktops, laptops, backups, archives, personal organizer, local systems, portable systems, etc. The data may be collected from multiple interfaces, such as Windows, Lotus Notes, Star Office, etc.

After the collected data is uploaded into a server, the document metadata, such as creation date, time last modified, etc., are petrified to preserve the integrity of file information; and the file types are identified.

During the conversion, document metadata and full text are extracted from the files; and the extracted data is indexed. In one embodiment, data for each file is converted to HTML; and duplicate files are identified. Relationships between emails and their attachments are identified and retained.

In one embodiment, a filtering module allows the user to construct queries which are applied to the indexed data to identify relevant documents for viewing. Results can be reviewed by the user for approval or rejection. If the results of the queries are approved, the selected documents are pushed forward to the review layer. If the results of the queries are rejected, the user can edit the current filter and reapply it or create a new query and run that. In one embodiment, approved filters are retained by the system for audit trail purposes.

In one embodiment, a task assignment module allows an administrator to parse out documents which have been pushed forward to the review layer to reviewers based on several optional criteria. This module also allows the administrator to determine how conflicting categorizations/classifications and privileged documents will be handled.

In one embodiment, a viewing module allows users to perform multiple functions, such as: advanced searching and viewing of search results; filtering document sub-sets based on multiple variables; global application of subjective or objective information to a select group of documents; and/or the searching and viewing of foreign language documents. Documents can be viewed individually, classified and annotated. Duplicate documents are identified in an easy to read fashion which allows for more efficient document review.

In one embodiment, a production module allows the administrator to identify and isolate documents which they would like to affix subjective or objective information. These documents can also be converted from their native format to various image formats.

In one embodiment, an export module, which can be implemented as a subsystem of the production module, which allows the administrator to export documents from the system to a predefined format. Documents can be exported into variety of formats from native to image formats. Data can be exported into a variety of predefined formats as well as user-defined formats.

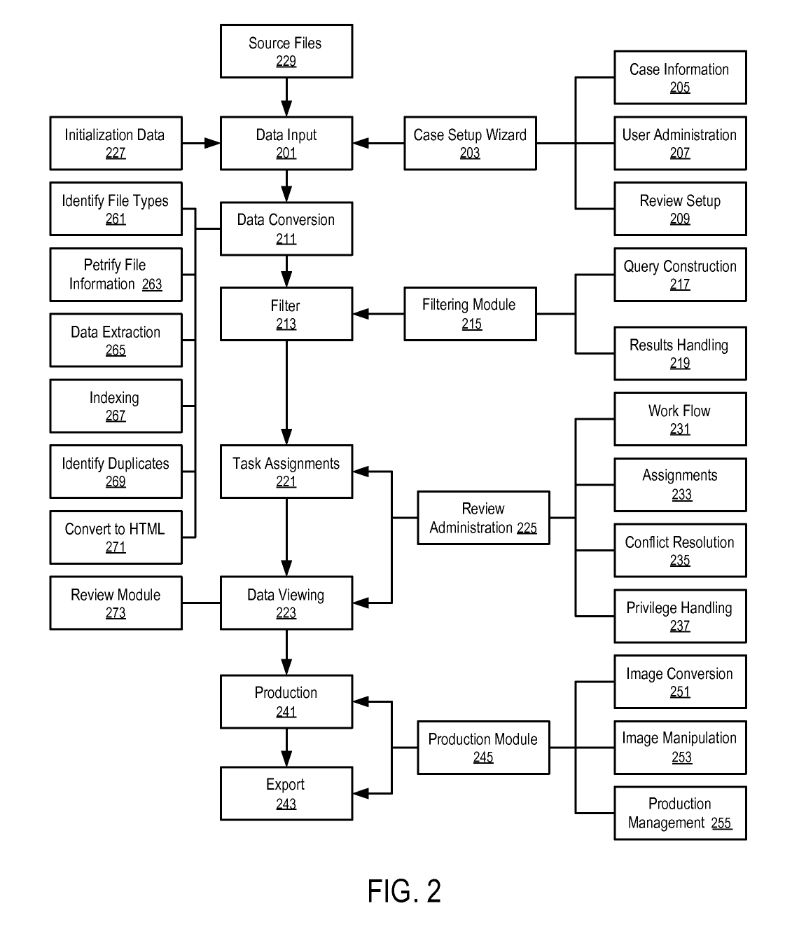

FIG. 2 shows a diagram of the use of modules of a system according to one embodiment. In FIG. 2, the system provides a rich set of functionalities, including multiple data types, multiple filtering criteria, administrative control of data sent for viewing by individual users, reporting, tracking of user time, and the ability to estimate project billing, etc.

In FIG. 2, after data input module (201) takes the initialization data (227) to set up the access for a customer entity, the source files (229) can be loaded into the system via the data input module (201). A case set up wizard (203) allows the administrator of the customer entity to specify case information (205), perform user administration (207), and review setup (209) of a project.

In FIG. 2, the data conversion module (211) converts the source files (229) that have been loaded into the system via the data input module (201). The data conversion (211) may automatically identify the file types (261), petrify file information (263), extract data (265) such as metadata and text, index (267) the extracted data, identify duplicates (269), convert the extracted data into an HTML format (271), etc.

In FIG. 2, a filtering module (215) can be used to construct filters (213) for the selection of documents and/or data. The filtering module (215) can be used by the customer entity to construct queries (217) and handle the results (219) of the queries.

In FIG. 2, a review administration module (225) can be used by the administrator of the customer entity to administrate the review process. Using the review administration module (225), tasks can be assigned (221) to different reviewers for data reviewing. Using the review administration module (225), the administrator can design the work flow (231), specify assignments (233), resolve conflicts (235) and/or handle privileges of different reviewers, etc.

After the data viewing, the production module (245) can be used for production (241) and export (243). The selected, edited, categorized/cataloged/classified, redacted, annotated documents can be exported into a format via image conversion (251) and image manipulation (253). The production module (245) allows an administrator of the customer entity to perform production management (255).

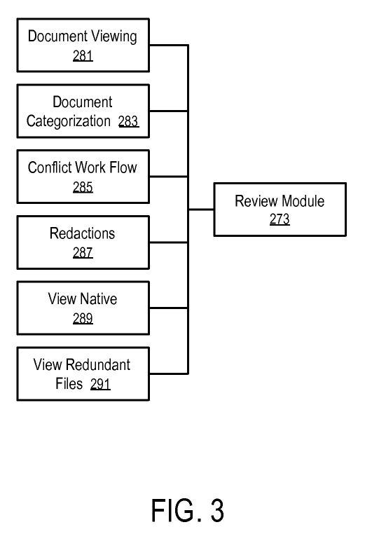

One or more reviewers can use the review module (273) to concurrently or sequentially review the data. FIG. 3 shows a review module according to one embodiment. Using the review module (273), a reviewer can view the documents in a converted image format (281), or in native applications (289), perform document categorization/classification (283) and/or redactions (287), to initiate a conflict resolution work flow (285), to view redundant files (291).

In FIGS. 2 and 3, many of these processes can be automated but the review is typically done by humans. The system processes can be manually administered by a human or set to work on their own to simplify administration in areas such as filtering, task assignment, and workflow for conflicts and special handling documents. This more automated approach ensures process integrity.

The monitoring capabilities built in the system provide administrators with an easy and accurate way to monitor reviewers, manage the review process, and estimate task completion.

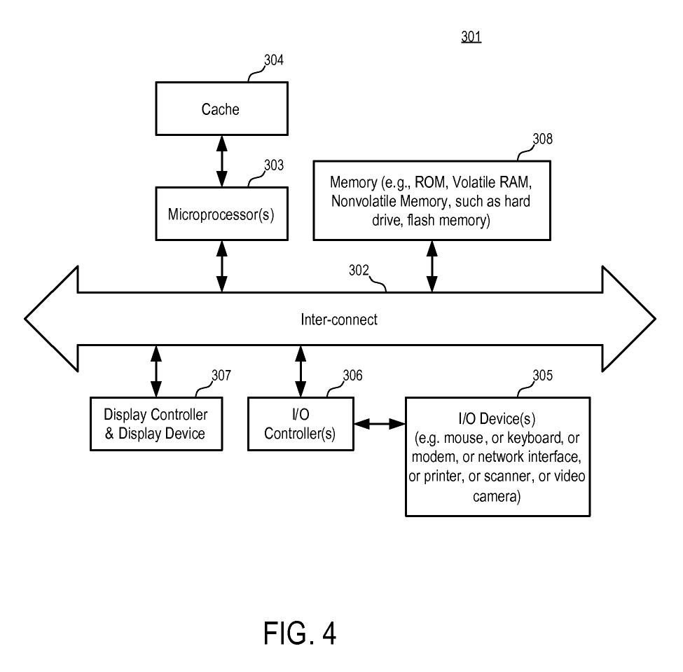

FIG. 4 shows a block diagram example of a data processing system which may be used in various embodiments. While FIG. 4 illustrates various components of a computer system, it is not intended to represent any particular architecture or manner of interconnecting the components. Other systems that have fewer or more components may also be used.

In FIG. 4, the communication device (301) is a form of a data processing system. The system (301) includes an inter-connect (302) (e.g., bus and system core logic), which interconnects a microprocessor(s) (303) and memory (308). The microprocessor (303) is coupled to cache memory (304) in the example of FIG. 4.

The inter-connect (302) interconnects the microprocessor(s) (303) and the memory (308) together and also interconnects them to a display controller and display device (307) and to peripheral devices such as input/output (I/O) devices (305) through an input/output controller(s) (306). Typical I/O devices include mice, keyboards, modems, network interfaces, printers, scanners, video cameras and other devices which are well known in the art.

The inter-connect (302) may include one or more buses connected to one another through various bridges, controllers and/or adapters. In one embodiment the I/O controller (306) includes a USB (Universal Serial Bus) adapter for controlling USB peripherals, and/or an IEEE-1394 bus adapter for controlling IEEE-1394 peripherals.

The memory (308) may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a server data processing system as illustrated in FIG. 4 is used as a web server to implement the interface (101), to implement the data converter (105), etc. In one embodiment, the one or more computer systems as illustrated in FIG. 4 can be used to implement the administration module, the review module, and/or the production module. In one embodiment, a data processing system as illustrated in FIG. 4 is used to implement entire system (111).

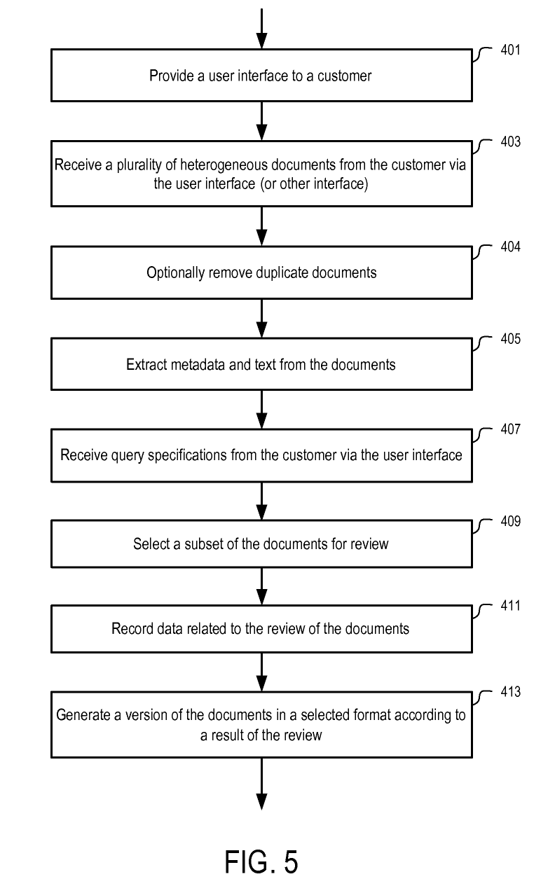

FIG. 5 shows a method for document management according to one embodiment. In FIG. 5, a user interface is provided (401) to a customer (e.g., via a web browser or a standalone application). After a plurality of heterogeneous digital files (e.g., audio documents, video documents, multimedia documents, text documents, graphical documents, spreadsheet documents, non-text documents, etc.) are received (403) from the customer via the user interface (or other interfaces), metadata and text are extracted (405) from the documents.

In one embodiment, the duplicate documents in the plurality of heterogeneous documents are automatically detected. The user may use the user interface to optionally remove (403) the duplicate documents.

After query specifications are received (407) from the customer via the user interface, a subset of the documents can be selected (409) for review via the queries applied on the extracted metadata and text according to the query specification.

In FIG. 5, data related to the review of the documents are recorded (411). During the review process, the documents can be edited, categorized/cataloged/classified, annotated, redacted, etc. A version of the documents can be generated (413) in a selected format according to a result of the review.

In one embodiment, heterogeneous data, regardless of origin (e.g., operating system, file type, file format, content type, etc), can be compiled into a single, unified system, which provides customers with the ability to control the managing of their data and to view, categorize/catalog/classify, annotate, convert, store and export their data according to their own specifications.

In one embodiment, documents of single or multiple file types can be processed for viewing and editing using a computer based system which imports heterogeneous data and converts the imported data to a generic format; and the converted data in the generic format can be then presented for viewing via a unified interface, such as a web browser or a graphical user interface client application.

In one embodiment, the computer based system allows users to set up and control a project. An interface for the creation of a project is provided to allow the customers to enter information describing the project. The user interface allows the customer to select how data will be processed and managed within the system, enter information regarding project specifics and data tracking information, create fields for annotating and classifying data stored in the system, creating user accounts on the system and setting up the level of functionality of the user accounts within the system, enter control information for data loaded into the system, import data into the computer system, group imported data into logical sets for tracking purposes, construct and apply queries to identify and isolate relevant information stored in the system, parse out of data to user accounts for viewing and annotating based on several variables, retract data parsed to a user account or a group of user accounts, and parse out the retracted data to a user account or a group of user accounts.

In one embodiment, an import module can be used to import one or more documents in one or more uploading operations.

One or more data tracking information sets can be created by the customer. Data imported into the computer system can be associated with a selected data tracking information set. Information related to creation, use and storage of the data or files that have been imported into the computer system is preserved. Metadata and text are extracted from the file or dataset that have been imported into the computer system and indexed as processed data. Redundant files in the imported data or files are identified. The processed data are queried to identify and isolate relevant documents, which can be parsed out to a user account or a group of user accounts for viewing and annotating based on multiple variables including data tracking information.

In one embodiment, metadata and/or text of a file or dataset imported into the system are captured and preserved. The metadata may include in the information about the creation, use, and storage of the original file or dataset imported into the system. In one embodiment, media specific information obtained from the file or dataset is preserved without alteration; environment specific information obtained from the file or dataset is preserved without alteration; origin information and relationship between files or datasets are preserved; and the collected information are normalized to a common format (e.g., HTML).

In one embodiment, heterogeneous files and datasets uploaded to the computer system are indexed for searching by the customer. In one embodiment, a user interface is provided to allow a customer to define the relevant information that needs to be indexed for future use. Relevant file information are then indexed according to the user specification. Relevant file information can be stored in different data stores such as text files, database, or XML metadata files. The indexed information may include file attributes and content as well as information internal to the system. The user interface provides a flexible way to define what is indexed. A customer may choose to index a single file, a set of files, or the entire data population available to the customer in the system. The user interface allows the customer to control the methodology used to perform the indexing task. For example, indexing can be performed for a batch, or for an entire set; a fresh index can be generated for a dataset, or an incremental index can be appended to the existing index.

In one embodiment, a user interface is provided to allow the customer to control the filtering process of heterogeneous files and datasets. The user interface can be used to define a set of filtering criteria. The filtering criteria can be related to information about or contained within a file that is stored in the system. The user interface can be used to define the range of files that the filter will be applied to. The system can schedule the filter execution, perform the execution of filter task, notify the customer about filter completion, and present the summary of filter results and their relationship to the data that have been previously filtered to the customer via the user interface. The user interface can be used by the customer to accept or reject filter results, to iteratively edit filter criteria to achieve the desired outcome. The system can save filter criteria for future reuse, automatically run filter criteria for incrementally added data, and track filter execution for auditing purposes.

In one embodiment, a user interface if provided to allow the customer to classify and annotate documents. A user can select file(s) and/or dataset(s) to view by choosing to view all files and/or datasets parsed to them or by searching their assigned dataset and selecting specific documents to view. The files and/or document sets are presented to the user one by one along with the customer defined classification and/or annotation fields for the project.

Using the interface, the user can review a document, select classification and/or annotation fields for that document, save the annotations for that document, and move to the next file or dataset in the viewing population.

In one embodiment, a module is provided to facilitate the file review(s). A user interface is provided to allow an administrator of the customers to assign files to multiple users of the customer for review. Based on the estimated work involved in the review, the assignments across the multiple users can be balanced. The user interface can be used to reassign files at any time, to monitor/track the review progress, to present the files for viewing a common format as well as their original format, to present file information for viewing, to allow the users to search for files to be viewed, to allow the users to narrow down population based on file information or content, to define custom categories for categorizing files, to track review information per item to track any conflicts, to assign conflicts to designated users, and/or to designate documents in particular categories for review by specially designated users, etc. In one embodiment, the access to the data being reviewed is protected by a permission and rights system.

In one embodiment, the data are filtered to facilitate file review(s). A simplified workflow is provided to allow for combining of the filtering and assignment for review process.

The data management system can be implemented via a client server model, or as a stand alone system, or as a hybrid system with client/server and a stand-alone system.

In one embodiment, the system uses multi-threaded, multi-processing, and distributed techniques to distribute the file processing, extraction, indexing, and filtering tasks to achieve an accelerated and scalable system while preserving the integrity of data. A centralized disk storage is used to share data across multiple processing nodes. Local file caching is used for improved processing performance. Centralized information store is used to keep track of data and review information.

In one embodiment, the system converts files to a common format through extracting data contained within a file's metadata or body-text and storing and converting the extracted data to a generic format which can be accessed and formatted for review in a unified matter.

In one embodiment, the system does not require file conversion to a common format but allows customers to view files of different file types within a unified viewer.

In one embodiment, the system removes multiple duplicate copies of a file from a file set for review. The system determines, using a flexible, fully configurable algorithm, a string value that identifies unique data in the system. Multiple occurrences of the same data are found within the information set. In one embodiment, the finding of the duplicate copies is customized based on the type of data. In one embodiment, the system records information about occurrence of each copy and provides a user interface to allow the end user to decide how to treat the multiple occurrences. Through the user interface, the user may indicate to the system to remove the additional copies, to show multiple copies, or to show a single copy while preserving information about the additional copies.

In one embodiment, the system then can remove and restore multiple copies of a file. Based on the preferences of the customer, when multiple copies of the same data occur in the system, they can be removed before the review process to reduce the number of files that have to be reviewed. After the review is finalized, the multiple copies can be re-introduced in the system. The re-introduced files preserve their unique data information while at the same time sharing review information.

In one embodiment, the system that allows dataset filtering into a smaller dataset. A user interface is provided to allow the user to define a filter (or filters) to reduce a dataset to relevant data. Data collections can be reduced by applying filtering criteria to available dataset(s). A previously designed filter can be automatically applied to a new dataset.

In one embodiment, the system allows data to be input one or more times. The system uses a de-duplication capability and advanced tracking and auditing to handle incremental inputs of data. Input points are designed to be reused multiple times. Data added for different instances of the system can be reused.

In one embodiment, the system is optimized for processing files for legal review. Features and interfaces are provided to make the system very suitable as a tool for legal review. For example, the system can support legal trail of evidence requirements in one embodiment. Data information lifecycle in the system is traced by extensive audit logs. The lifecycle of data prior to the input into the system can be tracked using forms and attributes entered by the user. A digital equivalent of the chain of custody form for every single file processed by the system can be created.

In one embodiment, the system can resolve resolving unknown file formats. Exceptions occurring during processing of a file are logged in the audit logs. In one embodiment, exception solving is automated using a pluggable framework that allows for integration of third party tools and software to allow for seamless processing. Exceptions that cannot be solved automatically are propagated to support users who are responsible for addressing the exception event. The exceptions do not impact the ability of the system to continue with data processing. The system can provide the end user with exception information in a report, which can be used to prioritize the exception handling process. In one embodiment, the exception handling framework is configured to learn about the new exception handlers and use them for future conflict/exception resolution.

In one embodiment, a flexible foundation for creating custom solutions tailored to the needs of particular group of users is provided. The system offers a flexible foundation, opened to the enhancements and extensions by third party vendors. The third party vendors can leverage the aspects of the platform and gathered information about datasets via a documented set of APIs and web services-based interfaces. An open architecture approach is used to provide users with not only a complete, self service file review system but with a system that can be completely tailored to their needs by using third party components tightly integrated into the system.

At least some embodiments, and the different structure and functional elements described herein, can be implemented using hardware, firmware, programs of instruction, or combinations of hardware, firmware, and programs of instructions.

In general, routines executed to implement the embodiments can be implemented as part of an operating system or a specific application, component, program, object, module or sequence of instructions referred to as “computer programs.” The computer programs typically comprise one or more instructions stored at various times in various memory and storage devices in a computer, and that, when read and executed by one or more processors in a computer, cause the computer to perform operations to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually affect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD-ROMs), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version.

Alternatively, the logic to perform the processes as discussed above could be implemented in additional computer and/or machine readable media, such as discrete hardware components as large scale integrated circuits (LSIs), application specific integrated circuits (ASICs), or firmware such as electrically erasable programmable read only memory (EEPROMs).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope as set forth in the following claims. The specification and drawings are, accordingly, to be regarded in an illustrative sense rather than a restrictive sense.

What is claimed is:

1. A method, comprising:
providing a user interface to a customer;
receiving a plurality of heterogeneous digital files from the customer;
receiving, via the user interface, a query specification from the customer to select a subset of the digital files according to the query specification;
receiving, via the user interface, input to manage a workflow for review of the subset of digital files;
receiving, via the user interface, input data related to the review of the subset of digital files; and
generating a version of the subset of digital files based on the received input data related to the review of the subset of digital files.

2. The method of claim 1, wherein the heterogeneous digital files comprise multimedia documents, text documents, spreadsheet documents, or non-text documents.

3. The method of claim 2, further comprising: extracting metadata, text, file attributes, or content from the heterogeneous digital files.

4. The method of claim 1, wherein the heterogeneous digital files are received via the user interface; and the heterogeneous digital files are from different computer operating systems or different application programs, in different languages or character sets, or having different file types or different file formats.

5. The method of claim 1, further comprising:
presenting the subset of digital files in an on-line uniform interface for review in a common format or in original formats of the subset of digital files; and
storing the generated data in a generic format to facilitate selection of the subset according to the query specification.

6. The method of claim 1, wherein the received input data related to the review of the subset of digital files includes input data to annotate, classify, catalog, categorize, edit, or redact a portion of the subset of digital files.

7. The method of claim 1, further comprising:
receiving input via the user interface to create a project, including information describing the project, information regarding project specifics, data tracking information, fields for annotating and classifying data, user accounts, levels of functionalities of the user accounts, and control information for the heterogeneous digital files; and
presenting the subset of digital files one by one along with the fields defined for the project for annotation or classification.

8. The method of claim 7, further comprising:
receiving input via the user interface to group data stored in the heterogeneous digital files;
receiving input via the user interface to parse out data to user accounts for viewing;
receiving input via the user interface to retract data parsed out to a user account or a group of user accounts; and
receiving input via the user interface to parse out the retracted data to a user account or a group of user accounts.

9. The method of claim 8, further comprising:
receiving input via the user interface to create one or more data tracking information sets;
receiving input via the user interface to associate a portion of data in the heterogeneous digital files with a data tracking information set; and
parsing out data to a user account or a group of user accounts based on one or more associated data tracking information sets.

10. The method of claim 9, further comprising:
receiving input via the user interface to define information to be indexed;
receiving input via the user interface to identify a portion of the heterogeneous digital files for indexing;
receiving input via the user interface to identify a methodology for indexing the identified portion of the heterogeneous digital files;
indexing data extracted from the identified portion of the heterogeneous digital files according to the identified methodology; and
querying the indexed data to select the subset.

11. The method of claim 10, wherein the query specification includes a set of filtering criteria; and the method further comprises:
presenting a summary of filter results obtained according to the query specification;
receiving input via the user interface to accept or reject the filter results;
storing accepted filtering criteria;
automatically applying the stored filtering criteria for incrementally added data; and
tracking filter execution.

12. The method of claim 1, further comprising:
receiving input via the user interface to assign files to multiple users for review, to balance the assignments across the multiple users based on the estimated work involved in the review, to reassign files, to monitor the review progress, to assign conflicts to designated users, to categorize files using custom categories, or to designate categories of digital files for review by designated users;
protecting data being reviewed via a permission and rights system;
receiving input via the user interface to search for files to be viewed, to narrow down search based on file information or content; and
tracking review information for conflicts.

13. The method of claim 1, further comprising:
combining filtering of the digital files and assigning of the digital files for review via the workflow.

14. The method of claim 1, wherein the method is implemented via a distributed processing system which uses multi-threaded, multi-processing, and distributed techniques to distribute file processing, extraction, indexing, and filtering tasks, a centralized disk storage to share data across multiple processing nodes, local file caching for improved processing performance, and centralized information store to keep track of data and review information.

15. The method of claim 1, further comprising:
determining, using a configurable algorithm, a string value to identify unique data;
finding multiple occurrences of the unique data based on a type of unique data;
recording information about occurrences of the unique data to allow an end user to select from options, including removal of duplications, showing multiple copies of the unique data, and showing a single copy of the unique data while preserving information about duplicate copies of the unique data.

16. The method of claim 15, further comprising:
removing duplicate copies of the unique data for review;
presenting one review copy of the unique data for review;
applying review information obtained via the review copy to duplicate copies of the unique data.

17. The method of claim 1, further comprising:
preserving media specific information of the heterogeneous digital files, environment specific information of the heterogeneous digital files, and origin information and relationship between the files or datasets;
tracking data information lifecycle after the plurality of heterogeneous digital files are received via the user interface;
tracking lifecycle of the heterogeneous digital files for a period prior to the receiving of the digital files via the user interface using forms and attributes entered by the user; and
creating a representation of chain of custody for the heterogeneous digital files.

18. The method of claim 1, comprising:
logging exceptions occurred during processing of a file;
accepting integration of one or more third party tools to solve the exceptions via a pluggable framework;
propagating exceptions that cannot be solved automatically to support users;
presenting exception information to an end user in a report;
receiving input from the end user to prioritize exception handling; and
automatically learning new exception handlers for use in future exception resolution.

19. A machine readable media embodying instructions, the instructions causing a machine to perform a method, the method comprising:
providing a user interface to a customer;
receiving a plurality of heterogeneous digital files from the customer;
receiving, via the user interface, a query specification from the customer to select a subset of the digital files according to the query specification;
receiving, via the user interface, input to manage a workflow for review of the subset of digital files;
receiving, via the user interface, input data related to the review of the subset of digital files; and
generating a version of the subset of digital files based on the received input data related to the review of the subset of digital files.

20. A computer system, comprising:
means for providing a user interface to a customer;
means for receiving a plurality of heterogeneous digital files from the customer;
means for receiving, via the user interface, a query specification from the customer to select a subset of the digital files according to the query specification;
means for receiving, via the user interface, input to manage a workflow for review of the subset of digital files;
means for receiving, via the user interface, input data related to the review of the subset of digital files; and
means for generating a version of the subset of digital files based on the received input data related to the review of the subset of digital files.
